(19) United States
(12) Patent Application Publication
(10) Pub. No.: US 2010/0203223 A1
(43) Pub. Date: Aug. 12, 2010

(54) PROCESS FOR MANUFACTURING SUN-DRIED TOMATOES UTILIZING VINEGAR

(75) Inventors: Cesar Corona, Newman, CA (US); Tim McGill, San Francisco, CA (US); Robert Benech, San Francisco, CA (US)

Correspondence Address: KELLY LOWRY & KELLEY, LLP, 6320 CANOGA AVENUE, SUITE 1650, WOODLAND HILLS, CA, 91367, US

(73) Assignee: VSP PRODUCTS, INC., Newman, CA (US)

(21) Appl. No.: 12/367,899

(22) Filed: Feb. 9, 2009

(51) Int. Cl. A23B 7/022

(52) U.S. Cl. 426/640

(57) ABSTRACT

In a process for manufacturing sun-dried tomatoes, sliced tomatoes are soaked in a batch formulation of vinegar at a ratio of four pounds of tomatoes to one gallon of vinegar. The vinegar-soaked tomato sections are dehydrated at 130° F. for sixteen hours. The dehydrated tomato sections are then placed in a sunlight environment and the moisture content is reduced to a range of fourteen percent to twenty-two percent.

### FIELD OF THE INVENTION

The present invention relates to a process for manufacturing sun-dried tomatoes. More particularly, the present invention relates to a process for manufacturing sun-dried tomatoes using a combination of soaking the tomatoes in vinegar, dehydrating the tomato sections and exposing them to a sunlight environment.

### BACKGROUND OF THE INVENTION

It is well known in the art that dehydrated products offer numerous advantages with respect to the original natural products, such as more prolonged preservation of quality, more efficient transportation and storage without refrigeration, less storage space per unit of solids, and considerable decrease in transportation costs per unit of solids.

One particular type of dehydrated food is sun-dried tomatoes. Sun-dried tomatoes are made from ripe tomatoes from which most of the moisture has been removed by allowing fresh tomatoes to dry in the sun. Using this process, as much as twenty pounds of fresh tomatoes can yield just one pound of sun-dried tomatoes. Sun-dried tomatoes have a stronger flavor than and the same nutritional content as the fresh tomatoes from which they are made.

The process of sun drying tomatoes originated in Italy. Persons living in Italy would dry their fresh tomatoes on their roofs as a way of preserving them so that they would last through the cold winter months. Today in the United States, sun-dried tomatoes are more often used as an ingredient in gourmet foods. However, sun-dried tomatoes can give a gourmet taste and feel to any ordinary recipe. Sun-dried tomatoes come in a wide variety of shapes and colors. While traditionally made from red tomatoes, i.e., red plum, they may also be made from yellow or any other variety of tomato.

There exists a need for a new process for manufacturing sun-dried tomatoes—a process that includes infusing the tomatoes with vinegar. The present invention fulfills this need and provides other related advantages.

### SUMMARY OF THE INVENTION

The present invention is directed to a process for manufacturing sun-dried tomatoes. The tomatoes are first washed and then sliced into sections. The tomato sections are placed into a vinegar bath to form a batch formulation. The batch formulation comprises a ratio of approximately three to five pounds of sliced tomatoes to approximately 0.6 to 1.5 gallons of vinegar. Preferably, the ratio of the batch formulation is closer to four pounds of sliced tomatoes to one gallon of vinegar. The tomato sections are soaked in the batch formulation for about three to seven minutes, preferably five minutes.

The tomato sections are then spread on a drying tray and dehydrated. The dehydration may be carried out between 115° F. to 150° F. for between twelve to twenty hours. Preferably, the dehydration is carried out at 130° F. for sixteen hours. The dehydrated tomato sections are then placed in a sunlight environment where the moisture content is further reduced to a range of fourteen percent to twenty-two percent.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawing illustrates the invention. In such drawing:

FIG. 1 is a flowchart illustrating a preferred embodiment of the inventive process.

### DETAILED DESCRIPTION OF THE PREFERRED EMBODIMENTS

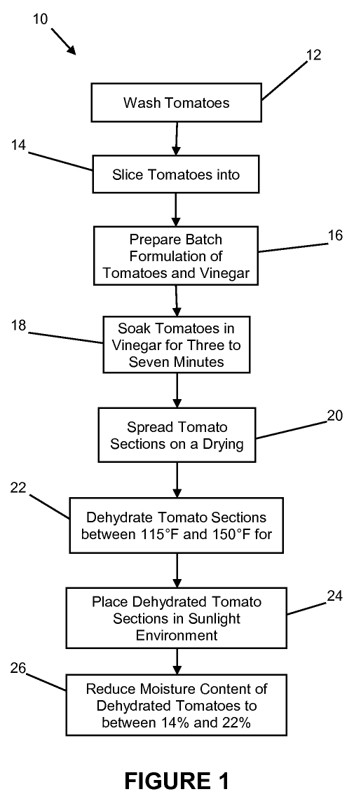

The present invention relates to a process for manufacturing sun-dried tomatoes utilizing a vinegar bath. The inventive process, generally referred to by reference numeral 10 in FIG. 1, presents a novel way of manufacturing sun-dried tomatoes.

In the preferred embodiment, the sun-dried tomato manufacturing process 10 begins with the step of washing 12 then slicing 14 one or more tomatoes into sections. The tomatoes are preferably Roma tomatoes but may be of any variety. The sections may comprise halves, quarters or some other portion of a whole tomato that provides a convenient size for consumption.

According to the process 10, after the tomatoes are sliced, a batch formulation of tomato sections and vinegar is prepared 16. The batch formulation comprises the sliced tomato sections and vinegar in a ratio of approximately three to five pounds of sliced tomatoes to approximately 0.6 to 1.5 gallons of vinegar. The present invention works best with a ratio of four pounds of sliced tomatoes to one gallon of vinegar. The sliced tomato sections are allowed to soak 18 in the vinegar for about three to seven minutes with a preferred time of five minutes.

After the tomato sections have been soaked in the vinegar, the tomato sections are spread 20 on a drying tray. The tomato sections are then placed in a dehydrator and dehydrated 22 to reduce the moisture content. The dehydration of the tomato sections is carried out at a temperature of between 115° F. to 150° F. for a period of between twelve to twenty hours. It has been determined that dehydration performed at 130° F. for sixteen hours produces a high quality product.

The dehydrated tomato sections are then placed 24 in a sunlight environment to allow for further drying. In the sunlight environment, the moisture content of the dehydrated tomato sections is further reduced 26 to a range of fourteen percent to twenty-two percent. Preferably, the moisture content is reduced to about eighteen percent.

Although an embodiment has been described in detail for purposes of illustration, various modifications may be made without departing from the scope and spirit of the invention. Accordingly, the invention is not to be limited, except as by the appended claims.

What is claimed is:

1. A process for manufacturing sun-dried tomatoes, comprising the steps of:
slicing a tomato into sections;
preparing a batch formulation of tomato sections and vinegar and soaking the tomato sections in the vinegar;
dehydrating the tomato sections;
placing the dehydrated tomato sections in a sunlight environment; and
reducing the moisture content of the dehydrated tomato sections to a range of 14% to 22%.

2. The process of claim 1, further comprising the step of washing the tomato before the slicing step.

3. The process of claim 1, wherein the batch formulation comprises the ratio of three to five pounds of sliced tomatoes to 0.6 to 1.5 gallons of vinegar.

4. The process of claim 3, wherein the batch formulation comprises the ratio of four pounds of sliced tomatoes to one gallon of vinegar.

5. The process of claim 1, wherein the soaking step lasts three to seven minutes.

6. The process of claim 5, wherein the soaking step lasts five minutes.

7. The process of claim 1, wherein the dehydrating step is carried out between 115° F. to 150° F. for between 12 to 20 hours.

8. The process of claim 7, wherein the dehydrating step is carried out at 130° F. for 16 hours.

9. A process for manufacturing sun-dried tomatoes, comprising the steps of:
slicing a tomato into sections;
preparing a batch formulation of three to five pounds of sliced tomatoes to 0.6 to 1.5 gallons of vinegar and soaking the tomato sections in the vinegar for three to seven minutes;
dehydrating the tomato sections between 115° F. to 150° F. for between 12 to 20 hours;
placing the dehydrated tomato sections in a sunlight environment; and
reducing the moisture content of the dehydrated tomato sections to a range of 14% to 22%.

10. The process of claim 9, wherein the batch formulation comprises the ratio of four pounds of sliced tomatoes to one gallon of vinegar.

11. The process of claim 9, wherein the soaking step lasts five minutes.

12. The process of claim 9, wherein the dehydrating step is carried out at 130° F. for 16 hours.

13. The process of claim 9, further comprising the step of washing the tomato before the slicing step.

14. A process for manufacturing sun-dried tomatoes, comprising the steps of:
slicing a tomato into sections;
preparing a batch formulation of four pounds of sliced tomatoes to 1 gallon of vinegar and soaking the tomato sections in the vinegar for five minutes;
dehydrating the tomato sections at 130° F. for 16 hours;
placing the dehydrated tomato sections in a sunlight environment; and
reducing the moisture content of the dehydrated tomato sections to a range of 14% to 22%.
